(19) United States
(12) Patent Application Publication
(10) Pub. No.: US 2025/0328728 A1
(43) Pub. Date: Oct. 23, 2025

(54) INTELLIGENT GENERATION OF DATA FOR A TABULAR DATA STRUCTURE VIA A LARGE LANGUAGE MODEL

(71) Applicant: Zira Technologies Inc., San Francisco, CA (US)

(72) Inventors: Lawrence Goldstein, San Francisco, CA (US); Jeremiah Pratt, Houston, TX (US); Rohan Saini, San Francisco, CA (US); Arjun Vora, Menlo Park, CA (US)

(21) Appl. No.: 19/187,005

(22) Filed: Apr. 23, 2025

Related U.S. Application Data
(60) Provisional application No. 63/637,628, filed on Apr. 23, 2024.

(51) Int. Cl. G06F 40/20; G06F 16/242

(52) U.S. Cl. CPC G06F 40/20; G06F 16/2428

(57) ABSTRACT

Embodiments provide for generating data for a data structure via artificial intelligence and/or machine learning and for intelligently generating prompts associated with the same.

### CROSS REFERENCE TO RELATED APPLICATIONS

This application claims priority to U.S. Appl. No. 63/637,628 filed Apr. 23, 2024, the contents of which are incorporated herein in its entirety by reference.

### TECHNOLOGICAL FIELD

Embodiments of the present disclosure generally relate to artificial intelligence and/or machine learning, and more particularly to generating data for a data structure via artificial intelligence and/or machine learning and for intelligently generating prompts associated with the same.

### BACKGROUND

Applicant has discovered problems with current techniques for generating data for a data structure that result in poor performance and/or other inefficiencies of the underlying computing systems. Through applied effort, ingenuity, and innovation, Applicant has solved many of these identified problems as discussed in the present disclosure.

### BRIEF SUMMARY

In an embodiment, an apparatus comprises one or more processors and one or more storage devices storing instructions that are operable, when executed by the one or more processors, to cause the one or more processors to determine context data for an intelligent data field of a tabular data structure based at least in part on one or more selected data fields of the tabular data structure. The instructions are additionally or alternatively operable, when executed by the one or more processors, to cause the one or more processors to input (i) the context data and (ii) a prompt that defines output data formatting criteria into a large language model to generate contextually-relevant content data for the intelligent data field. The instructions are additionally or alternatively operable, when executed by the one or more processors, to cause the one or more processors to populate the intelligent data field of the tabular data structure with the contextually-relevant content data generated by the large language model.

In another embodiment, a computer-implemented method provides for determining context data for an intelligent data field of a tabular data structure based at least in part on one or more selected data fields of the tabular data structure. The computer-implemented method additionally or alternatively provides for inputting (i) the context data and (ii) a prompt that defines output data formatting criteria into a large language model to generate contextually-relevant content data for the intelligent data field. The computer-implemented method additionally or alternatively provides for populating the intelligent data field of the tabular data structure with the contextually-relevant content data generated by the large language model.

In yet another embodiment, one or more non-transitory computer-readable storage media store instructions that, when executed by one or more processors, cause the one or more processors to determine context data for an intelligent data field of a tabular data structure based at least in part on one or more selected data fields of the tabular data structure. The instructions, when executed by the one or more processors, additionally or alternatively cause the one or more processors to input (i) the context data and (ii) a prompt that defines output data formatting criteria into a large language model to generate contextually-relevant content data for the intelligent data field. The instructions, when executed by the one or more processors, additionally or alternatively cause the one or more processors to populate the intelligent data field of the tabular data structure with the contextually-relevant content data generated by the large language model.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced. Having thus described the embodiments of the disclosure in general terms, reference now will be made to the accompanying drawings, which are not necessarily drawn to scale, and wherein:

FIG. 1 illustrates a block diagram of a system that can be specially configured within which at least one example embodiment of the present disclosure may operate;

FIG. 2 illustrates a block diagram of an example apparatus that can be specially configured in accordance with at least one example embodiment of the present disclosure;

FIGS. 3, 4, 5, 6, 7, 8, 9, 10, 11, 12, 13, 14, 15, 16, and 17 respectively illustrate an example user interface in accordance with at least one example embodiment of the present disclosure; and

FIG. 18 illustrates a process depicting example operations for providing intelligent generation of data for a tabular data structure via a large language model in accordance with at least one embodiment of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure can be embodied in many different forms and should not be construed as limited to the embodiments set forth herein, rather, these embodiments are provided so that this disclosure will satisfy applicable legal requirements. Like numbers refer to like elements throughout.

### Overview

Certain types of data structures such as a data structure accessible via a network can be repeatedly updated with new data based on human interaction via a user device or another type of computing device. However, updating data for a data structure via human interaction is often computationally time-consuming, resource intensive, and/or prone to errors. For example, a tabular data structure (e.g., a spreadsheet) accessible via a network may include various data fields arranged in rows and columns, a vast amount of data, and/or data provided by different user devices. As compared to a data structure with a data field that is directly modified by a single entity, computational resource usage requirements for a computing system may also exponentially increase while being repeatedly updated with new data based on human interaction when factoring in various data structures with various data fields, a vast amount of data, and/or data provided by different user devices. Moreover, certain types of automated actions such as automated generation of new data within the spreadsheet, automated notifications and/or automated initiation of third-party workflows may be desirable via a network and/or a user device based on the type of data stored in a data structure. As such, improving performance, efficiency, and/or capabilities of a data structure and/or related computing system is desirable.

Embodiments of the present disclosure address technical challenges related to generating and/or managing data associated with a data structure in a computationally efficient, accurate, reliable, and automated manner. Various embodiments of the present disclosure provide for intelligent generation of data for a tabular data structure (e.g., data within cells in rows and/or columns of a spreadsheet) via a large language model. For example, a large language model may be integrated with and/or accessible by a tabular data structure database platform to improve performance and/or efficiency of the tabular data structure database platform for generating data associated with tabular data structures. In this regard, the large language model may enable automated generation/population of contextually relevant data into one or more intelligent data fields of a tabular data structure, thereby reducing human interaction with the tabular data structure via a user device or another type of computing device. By utilizing the large language model to determine and generate the contextually relevant content for the one or more intelligent data fields, a number of computing resources for managing the tabular data structure may be reduced as compared with more complex models for generating content. As a specific example, the large language model may generate contextually relevant content for one or more intelligent data fields (the intelligent data fields being designated by a user as an intelligent data field) based at least in part on content data within other cells/rows/columns within the same tabular data structure that are designated as contextual data to be used as input for the large language model. Additionally, a number of errors in the tabular data structure may be reduced, thereby improving the quality of data in the tabular data structure and/or improving the accuracy of subsequent automated actions related to the tabular data structure. As just one example, the configuration as discussed herein utilizes a large language model that uses the user-designated contextual data (as discussed above) as input, along with input data designating the output domain to be utilized by the model (e.g., a user may designate a predefined set of optional content that may be output; or the user may designate a type of output (names; places; alphanumeric strings; dates; currency values; and/or the like). Lastly, the large language model may utilize one or more prompts (e.g., automatically generated; manually entered user input; and/or a combination thereof) to provide information to the large language model of the type of output to be generated. As a specific example, the large language model may receive a prompt to “input the person on leave for the denoted week;” may receive an indication of an appropriate output domain “names” selected from a specific column in the spreadsheet; and may receive an indication that the context data includes a column listing various weeks and a column listing names. Moreover, by leveraging the computational capabilities of the large language model to analyze relationships between data fields of the tabular data structure (specifically the contextual data designated by the user) and generate the contextually relevant data, more advanced insights and data content for the tabular data structure may be provided as compared to traditional database management techniques. Moreover, according to certain embodiments, a system may utilize the output generated by the large language model to trigger various actions, including populating additional content; providing notifications; and/or initiating a third party workflow (e.g., sending an email using a third party email agent to the person who is indicated as “on leave” for a given week).

In various embodiments, an intelligent data field (e.g., a smart field) of a tabular data structure can be automatically populated with data provided as output from a large language model. For example, an intelligent data field (e.g., a smart field) may be a particular data field of a tabular data structure that is populated with data provided by a large language model. In some embodiments, the system (e.g., the tabular data structure platform) may receive user input from a graphical user interface that designates one or more cells as intelligent data fields (e.g., selecting a particular column of cells; selecting a particular row of cells; and/or selecting an individual cell). In various embodiments, data for the intelligent data field may be generated by the large language model, using context associated with one or more other data fields (e.g., the context determined based on the content of the one or more other data fields) of the tabular data structure. The context is provided in the form of contextual data that may limit or guide the type of data that is entered into the intelligent data field (e.g., numbers, date, name, description, etc.). For example, the context may refer to information or data provided as input to the large language model to provide relevance and/or meaning with respect to the intelligent data field. In some embodiments, the context may include information or data in certain types of data fields in the tabular data structure, structure or formatting of data fields in the tabular data structure, relationships between data fields in the tabular data structure, content of data fields in the tabular data structure, and/or other contextual insights related to data fields in the tabular data structure. In various embodiments, the context used for limiting or guiding the output of the large language model may be manually selected. For example, the system may be configured to receive user input selecting one or more other data fields via a graphical user interface to determine the context (e.g., context data) for the intelligent data field. In some examples, an interactive user interface element (e.g., an interactive widget, a software wizard, etc.) can be configured for setting up an intelligent data field. In some embodiments, an interactive user interface element of the graphical user interface can be configured to receive an indication of the one or more other data fields from a user. In some embodiments, an interactive user interface element can be utilized to determine input for a large language model, a data format for output of a large language model, context for data provided by a large language model, etc. For example, input for a large language model can be determined based on user input provided via an interactive user interface element of a user interface. Additionally or alternatively, a data format and/or context for output of a large language model can be determined based on user input provided via an interactive user interface element of a user interface. It should be understood that large language models are trained on massive data sets, and may use large amounts of input to customize the output so that the output is likely to be what the user is desiring. In this regard, the large language model may use all of the data within a particular tabular data structure (e.g., spreadsheet) as input data, and the manually-designated contextual data may be given a higher importance weighting to the large language model when generating output, as compared with the non-designated data.

In various embodiments, one or more actions can be initiated based on the data populated into the intelligent data field and/or provided by a large language model. The one or more actions may include an action within the tabular data structure, an action with respect to a database that stores the tabular data structure and/or one or more other tabular data structures, an action using a third-party application, an action with respect to a network, an action using an application programming interface (API), an action with respect to a user device, an action with respect to a user interface, and/or another type of action. As specific examples, the actions may include populating one or more additional data fields (an action for populating data within the tabular data structure or an action for populating data within a separate tabular data structure); generating a notification (e.g., generating a notification within the tabular data structure so that users may receive the notification (a graphical or audio notification) when opening the tabular data structure; generating a notification within a separate tabular data structure, such that users may receive the notification (a graphical or audio notification) when opening the separate tabular data structure; generating a push notification, such that users may receive the notification, regardless of whether they are interacting with any aspect of the database); and/or initiating a third-party workflow (e.g., sending a signal to a third-party application to cause the third-party application to initiate and execute a particular workflow to cause the third-party application to complete a task (e.g., opening an email agent to cause the email agent to send an email using information from the tabular data structure, opening a calendar application to add a meeting/appointment using information from the tabular data structure, opening an expense application to populate an expense report, and/or the like). For example, a system, model, or virtual agent can be configured to automatically generate an email based on certain criteria associated with the intelligent data field (e.g., when data is not entered into the intelligent data field within a particular interval of time). Additionally, in various embodiments, a system, model, or virtual agent can extract data from an intelligent data field and/or can provide the extracted data and to a third-party application (e.g., an email application, etc.) to initiate one or more alerts, one or more notifications, and/or other actions associated with the intelligent data field.

In a non-limiting example, the tabular data structure can be a spreadsheet database (e.g., a backend spreadsheet application) that stores one or more spreadsheets. A spreadsheet may be a particular type of tabular data structure that includes a set of rows and a set of columns with intersecting data fields (e.g., data cells). A data field (e.g., a data cell) may include a data value, numbers, a formula, text (e.g., an alphanumeric string, a text string, and/or the like), a reference to another data field, or other data. A row may represent a horizontal arrangement of data fields that extends across multiple columns. A column may represent a vertical arrangement of data fields that extends across multiple rows. Additionally, one or more large language models can be integrated with the spreadsheet database to generate one or more intelligent data fields (e.g., one or more smart fields) for one or more spreadsheets stored in the spreadsheet database. For example, a user may provide input using a graphical user interface to designate cells within a column as intelligent data fields, such that one or more data fields of the column of the spreadsheet can be configured to automatically populate with data using specific context from other data fields (e.g., other data cells) within a particular row of the spreadsheet. As discussed herein, designating one or more cells as intelligent data fields may cause the database platform to call-up a setup wizard that requests the user to provide user input designating cells as contextual data; designating the output domain (e.g., the type of data that may be output into the cell) and/or to provide a prompt requesting the large language model to generate a particular type of output. In some examples, a single data field (e.g., an intelligent data field) of a column of a spreadsheet can be designated as an intelligent data field and configured to automatically populate with data using specific context from other data fields (e.g., other data cells) within a particular row of the spreadsheet. In some examples, a data field (e.g., an intelligent data field) of a column of a spreadsheet can be configured to automatically populate with data using specific context from other data fields (e.g., other data cells) within a particular row of the spreadsheet and/or one or more other data fields of the column can be updated based on the automatically populated data for the data field (e.g., the intelligent data field). In various embodiments, the data that is automatically populated for the column can be provided by one or more large language models. In some embodiments, a new column of the spreadsheet can be designated as an intelligent data field based on a user interaction with respect to the column (e.g., a “right click” action via user interface). Additionally, one or more other columns can be selected to define context for the intelligent data field.

Challenges associated with using large language models are overcome by embodiments of the present disclosure. While large language models may find use in assisting with various data analyses and tasks, the output from the models is only useful if it makes sense for the intended task. In order to ensure the output from the models is useful, careful generation of prompts to input to the models is preferred. That is, while a series of prompts can be generated and provided to a large language model to eventually arrive at a desired output, such generation of the series of prompts requires continuous refining of the prompts to arrive at the desired output. A brute force approach to generating a series of prompts wastes valuable computing and other resources and may result in arriving at the desired output after the underlying data is no longer fresh or relevant. Accordingly, optimizing prompts for input to a large language model such that the prompts are minimal (e.g., one prompt is required) and designed in a manner to ensure the output is what is desired for the task at hand, is valuable and necessary to conserve resources and achieve results while underlying data remains fresh and relevant (e.g., has not changed in the meantime). Embodiments herein provide for prompt engineering of an intelligent data field by intelligently generating one or more prompts to define criteria in order to ensure the desired output from the one or more large language models. In some embodiments, the one or more large language models may utilize a set of intelligent cascading prompts to determine criteria for the output of the one or more large language models. For example, one or more subsequent prompts can be independently generated and/or utilized based on analysis and/or insights with respect to data in one or more tabular data structures.

### Example Systems

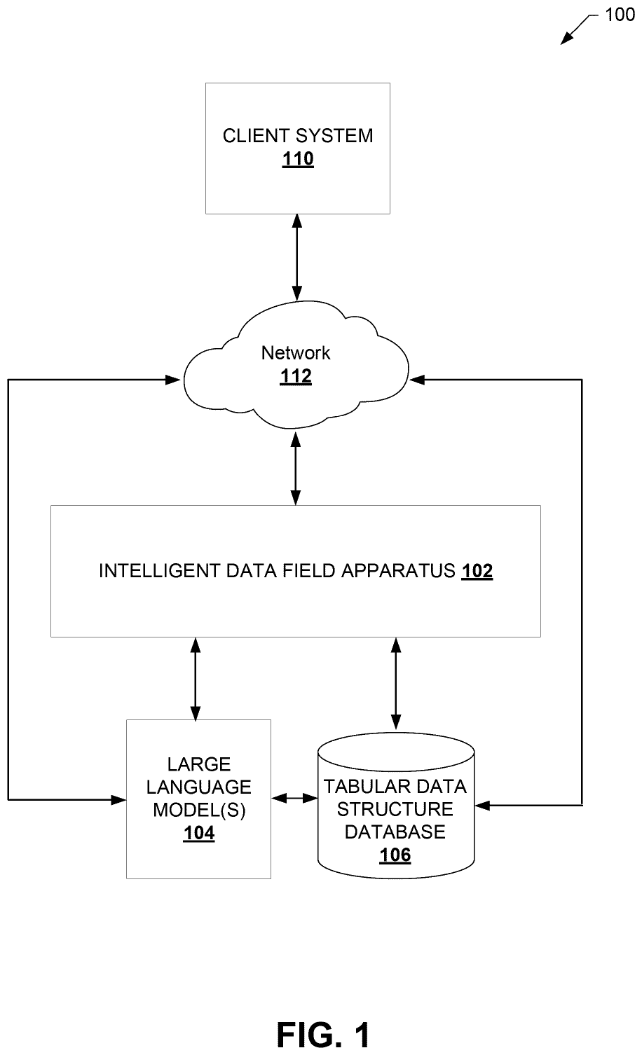

FIG. 1 illustrates a block diagram of a system that can be specially configured for maintaining a database and generating data within an intelligent field of a tabular database, as discussed with respect to various embodiments. Specifically, FIG. 1 illustrates an example system 100. The example system 100 includes an intelligent data field apparatus 102, one or more large language models 104, a tabular data structure database 106, and/or a client system 110. In one or more embodiments, the system 100 includes at least one network 112 that enables transmission of data between one or more subsystem(s) and/or device(s) of the system 100.

The intelligent data field apparatus 102 includes one or more computer(s) embodied in hardware, software, firmware, and/or a combination thereof. In some embodiments, the intelligent data field apparatus 102 includes one or more application server(s), database server(s), enterprise computing terminal(s), and/or the like that are configured to perform the functionality described herein. In some embodiments, the intelligent data field apparatus 102 embodies or includes a backend system (e.g., one or more enterprise server(s)) that are communicable over one or more network(s) (e.g., via the Internet). Additionally or alternatively, in some embodiments, the intelligent data field apparatus 102 includes one or more virtual computer(s) embodied in a software environment maintained via particular hardware, for example where the intelligent data field apparatus 102 is maintained as a virtual environment on hardware of a central terminal supporting multiple software application(s). In some embodiments, the intelligent data field apparatus 102 includes one or more hardware device(s) within the same physically defined space, such as a data warehouse, company headquarters, and/or the like associated with a particular entity. Alternatively or additionally, in some embodiments, the intelligent data field apparatus 102 includes one or more hardware and/or software device(s) located remotely from one another and that communicate in conjunction with one another to provide the described functionality, for example embodied by one or more cloud computing system(s).

In some embodiments, the intelligent data field apparatus 102 includes a plurality of sub-services that each support a portion of the functionality performed by the intelligent data field apparatus 102. In some such embodiments, the plurality of sub-services may each be embodied by different hardware, software, firmware, and/or any combination thereof. Alternatively or additionally, in some embodiments, one or more of the sub-services share particular hardware, software, firmware, and/or any combination thereof. For example, in some embodiments, the intelligent data field apparatus 102 may embody specially-configured software applications executed on shared hardware.

In some embodiments, the intelligent data field apparatus 102 supports a tabular data structure database platform and/or an Al platform for generating data related to one or more data fields of one or more tabular data structures stored in the tabular data structure database 106. In some embodiments, the tabular data structure database 106 can be spreadsheet database (e.g., a backend spreadsheet database) that stores one or more spreadsheets. A spreadsheet of the one or more spreadsheets may be a particular type of tabular data structure that includes a set of rows and a set of columns with intersecting data fields (e.g., data cells). A data field (e.g., a data cell) may include a data value, numbers, a formula, text, a reference to another data field, or other data. A row may represent a horizontal arrangement of data fields that extends across multiple columns. A column may represent a vertical arrangement of data fields that extends across multiple rows. In some embodiments, the tabular database platform and/or the Al platform is associated with a workflow application, a workspace application, a workflow management application, a scheduling application, a document management application, a personnel management application, a time management application (e.g., a time clock application), a billing application, a reporting application, and/or another type of application associated with a server platform. In some embodiments, the intelligent data field apparatus 102 additionally or alternatively provides one or more functionalities associated with the client system 110.

In some embodiments, the intelligent data field apparatus 102 utilizes the one or more large language models 104 to generate data within data fields (within data fields designated by the user as intelligent data fields) related to one or more data fields of one or more tabular data structures stored in the tabular data structure database 106. In some embodiments, a large language model of the one or more large language models 104 can be a data construct that describes parameters, hyperparameters, and/or defined operations configured to generate data for one or more data fields of a tabular data structure stored in the tabular data structure database 106. In some embodiments, a large language model of the one or more large language models 104 can be a model that is configured, trained, and/or the like to generate data (e.g., natural language data and/or a data object) in response to a prompt, context data, and/or other data related to a tabular data structure. Additionally, a large language model can include any type of large language model, such as, but not limited to, a generative pre-trained transformer (GPT) model, and/or the like. In some embodiments, a tabular data structure database platform and/or an Al platform can include the intelligent data field apparatus 102 and the one or more large language models 104. For example, the one or more large language models 104 can be a first party model for the intelligent data field apparatus 102. In some embodiments, the one or more large language models 104 can be a third-party model that is communicatively coupled to the intelligent data field apparatus 102 via the network 112.

In some embodiments, a large language model of the one or more large language models 104 is trained and/or retrained for one or more data field tasks associated with intelligent data fields. Training a large language model can include modifying and/or optimizing parameters, hyperparameters, coefficients, weights, biases, defined operations, and/or the like for the large language model. In some embodiments, a large language model of the one or more large language models 104 can be trained using a training dataset associated with a specific entity and/or specific entity domain. For example, a training dataset for a large language model of the one or more large language models 104 can correspond to data associated with a particular entity and/or specific entity domain. Alternatively, in some embodiments, a large language model of the one or more large language models 104 can be trained using a training dataset associated with two or more entities and/or two or more entity domains. For example, a training dataset for a large language model of the one or more large language models 104 can correspond to data associated with a two or more entities and/or two or more entity domains. In some embodiments, a training dataset for a large language model of the one or more large language models 104 can correspond to data without a specific association to an entity and/or entity domain. In some embodiments, the large language model is trained, at least in part, using data arranged in a tabular data structure. By providing training data to the large language model in a tabular data structure, the large language model is provided with data that demonstrates how to maintain structure in a tabular data structure when adding new data to individual fields within rows and/or columns of the tabular data structure. In this manner, the large language model is trained to recognize how certain data fields remain contextually relevant to other data fields within the tabular data structure. As discussed herein, when the large language model is executed to infer data for providing into a field, and certain data is designated as “context” for populating the field, the large language model's training data enables the large language model to determine how that context can be used to infer content for an individual cell.

The large language model receives and uses input for generating data within intelligent data fields. The input is provided by the user using a graphical user interface wizard that guides the user to provide the specific types of data input needed, such as, but not limited to, context data (e.g., other data within the tabular data structure), output domain defining data (e.g., designating certain output values that may be input into the cell), and/or a prompt requesting the user to indicate what output should be added to the cell. In some embodiments, the wizard may additionally request the user to indicate any actions that should be performed based on the values generated for the intelligent data fields (e.g., actions for generating additional content; actions for generating notifications; and/or actions for initiating third party work-flows).

In some embodiments, the client system 110 embodies a user device and/or end terminal accessible by a user to initiate functionality via the intelligent data field apparatus 102. For example, in some embodiments, a user enters authentication credentials via the client system 110 that are validated to initiate an authenticated database session associated with the intelligent data field apparatus 102, such that the user may utilize the client system 110 to access functionality of the intelligent data field apparatus 102, the tabular data structure database 106, and/or data associated therewith. The client system 110 in some embodiments is utilized to initiate one or more indication(s) of a trusted processing request. Additionally or alternatively, in some embodiments, the client system 110 is utilized to render electronic interface(s) that provide and/or configure details associated with the tabular data structure database 106 and/or the like. In some such embodiments, the client system 110 operates as a front-end or user-facing application for accessing such functionality of the intelligent data field apparatus 102.

In some embodiments, the intelligent data field apparatus 102 supports automatically receiving data transmissions, for example embodied by API request(s), procedure call(s), and/or other digital data transfers, that embody a request. Additionally or alternatively, in some embodiments, the intelligent data field apparatus 102 supports providing data via digital mechanism(s) (e.g., graphical user interfaces, customized dashboards, widgets, email, electronic portals, electronic communication channels, FTP, large language models, and/or the like).

The network 112 can be a communications network and/or can be configurable to be embodied in any of a myriad of network configurations. In some embodiments, the network 112 embodies a public network (e.g., the Internet). In some embodiments, the network 112 embodies a private network (e.g., an internal, localized, or closed-off network between particular devices). In some other embodiments, the network 112 embodies a hybrid network (e.g., a network enabling internal communication between particular connected devices and external communication with other devices). The network 112 in some embodiments includes one or more base station(s), relay(s), router(s), switch(es), cell tower(s), communications cable(s) and/or associated routing station(s), and/or the like. In some embodiments, the network 112 includes one or more computing device(s) controlled by individual entities (e.g., an entity-owner router and/or modem) and/or one or more external utility devices (e.g., Internet service provider communication tower(s) and/or other device(s)).

The computing devices of the system 100 may each communicate in whole or in part over a portion of one or more communication network(s), such as the network 112. For example, each of the components of the system 100 can be communicatively coupled to transmit data to and/or receive data from one another over the same and/or different wireless or wired networks embodying the network 112. Non-limiting examples of network configuration(s) for the network 112 include, without limitation, a wired or wireless Personal Area Network (PAN), Local Area Network (LAN), Metropolitan Area Network (MAN), Wide Area Network (WAN), and/or the like. Additionally, while FIG. 1 illustrates certain system entities as separate, standalone entities communicating over the communications network(s), the various embodiments are not limited to this particular architecture. In other embodiments, one or more computing entities share one or more components, hardware, and/or the like, or otherwise are embodied by a single computing device such that connection(s) between the computing entities are altered and/or rendered unnecessary. Alternatively or additionally still, in some embodiments the network 112 enables communication to one or more other computing device(s) not depicted, for example client device(s) for accessing functionality of any of the subsystems therein via native and/or web-based application(s), and/or the like.

### Example Apparatus

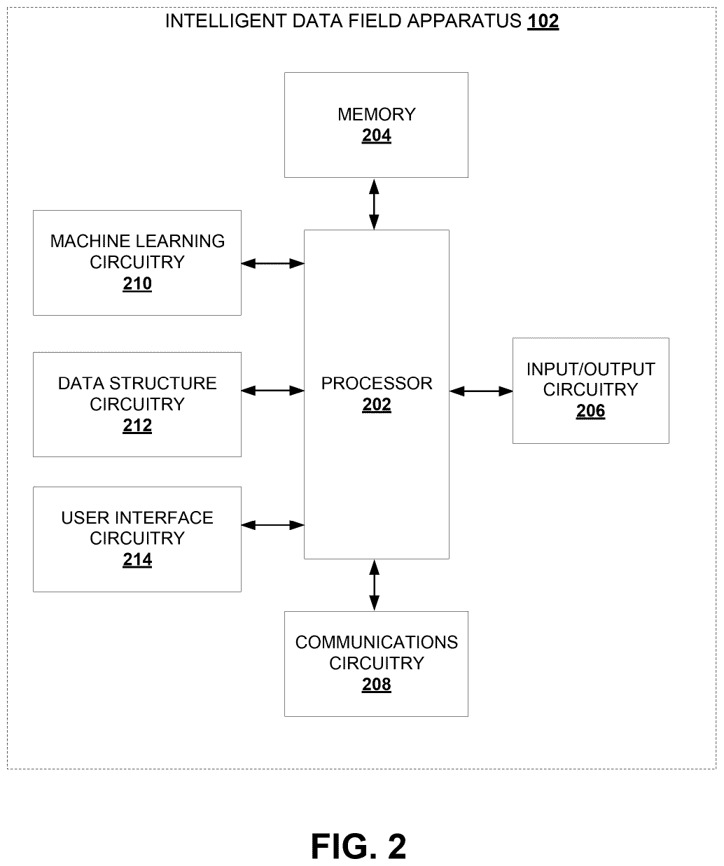

FIG. 2 illustrates a block diagram of an example apparatus that can be specially configured in accordance with at least one example embodiment of the present disclosure. Specifically, FIG. 2 illustrates the intelligent data field apparatus 102 in accordance with at least one example embodiment of the present disclosure. The intelligent data field apparatus 102 includes processor 202, memory 204, input/output circuitry 206, communications circuitry 208, machine learning circuitry 210, data structure circuitry 212, and/or user interface circuitry 214. In some embodiments, the intelligent data field apparatus 102 is configured, using one or more of the sets of circuitry 206, 208, 210, 212, and/or 214, to execute and perform one or more of the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the intelligent data field apparatus 102 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the intelligent data field apparatus 102 provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the memory 204 via a bus for passing information among components of the intelligent data field apparatus 102. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the intelligent data field apparatus 102 to carry out various functions in accordance with example embodiments of the present disclosure.

The processor 202 can be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the intelligent data field apparatus 102, and/or one or more remote or “cloud” processor(s) external to the intelligent data field apparatus 102.

In an example embodiment, the processor 202 is configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed. In some embodiments, the processor 202 includes or is embodied by a CPU, microprocessor, and/or the like that executes computer-coded instructions, for example stored via the non-transitory memory 204.

In some embodiments, the intelligent data field apparatus 102 includes input/output circuitry 206 that provides output to the user and, in some embodiments, to receive an indication of a user input. In some embodiments, the input/output circuitry 206 is in communication with the processor 202 to provide such functionality. The input/output circuitry 206 may comprise one or more user interface(s) and in some embodiments includes a display that comprises the interface(s) rendered as an electronic interface, a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor can be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a client device and/or other display associated with a user. In some embodiments, the input/output circuitry 206 includes hardware, software, firmware, and/or a combination thereof, that facilitates simultaneously display of particular data via a plurality of different devices.

In some embodiments, the intelligent data field apparatus 102 includes communications circuitry 208. The communications circuitry 208 includes any means such as a device or circuitry embodied in either hardware or a combination of hardware and software that is configured to receive and/or transmit data from/to a network and/or any other device, circuitry, or module in communication with the intelligent data field apparatus 102. In this regard, in some embodiments the communications circuitry 208 includes, for example, a network interface for enabling communications with a wired or wireless communications network. Additionally or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from a client device, capture device, and/or other external computing device in communication with the intelligent data field apparatus 102.

In some embodiments, the intelligent data field apparatus 102 includes the machine learning circuitry 210. The machine learning circuitry 210 includes hardware, software, firmware, and/or a combination thereof, that supports various functionality associated with the one or more large language models 104. For example, in some embodiments, the machine learning circuitry 210 includes hardware, software, firmware, and/or a combination thereof, that selects a large language model from the one or more large language models 104. In some embodiments, the machine learning circuitry 210 includes hardware, software, firmware, and/or a combination thereof, that determines context data for an intelligent data field of a tabular data structure stored in the tabular data structure database 106 based at least in part on one or more other data fields of the tabular data structure. The context data may include information that impacts data for an intelligent data field of the tabular data structure. For example, the context data may include data included in one or more other data fields of the tabular data structure. Additionally or alternatively, the context data may include data obtained outside the tabular data structure such as, but not limited to, metadata, user-selectable information related to one or more data fields of the tabular data structure, user-selectable information via a predefined list of context classes, relational database insights, machine learning output, and/or other context data. In some embodiments related to workforce management, the context data may include a geographic location of a user identifier, a timestamp associated with a Radio-Frequency Identification (RFID) tracking system for a user identifier, one or more attributes associated with a user identifier, a textual description, natural language processing information, and/or other context data. In some embodiments, the machine learning circuitry 210 includes hardware, software, firmware, and/or a combination thereof, that additionally or alternatively generates content data for the intelligent data field using the one or more large language models 104. In some embodiments, the one or more large language models 104 generate the content data based at least in part on the context data and/or a prompt that defines criteria for the content data. In some embodiments, the prompt is a second prompt that is generated subsequent to a first prompt. For example, the prompt can be included in a set of intelligent cascading prompts that is generated and/or utilized to define criteria for the content data. In some embodiments, the prompt can be generated automatically (e.g., using an artificial intelligence model trained to build prompts) based at least in part on data associated with one or more other data fields of the tabular data structure stored in the tabular data structure database 106. Additionally or alternatively, the prompt can be a second prompt that is generated subsequent to a first prompt. For example, the prompt can be a subsequent prompt that is independently generated and/or utilized based on analysis and/or insights with respect to data of the tabular data structure stored in the tabular data structure database 106. In some embodiments, the second prompt may be generated to request additional context relating to the first prompt, and the second prompt may be generated based at least in part on an analysis (e.g., an automated analysis performed by an artificial intelligence model configured to build prompts). Where an artificial intelligence model is utilized to generate one or more prompts, the artificial intelligence model may be a large language model trained to generate output including a textual prompt together with one or more input fields. The one or more input fields may be formatted by the artificial intelligence model to accept a particular type of input from a user. For example, the input field(s) may include a freeform textual input field, a dropdown selection (with a plurality of defined options for selection, with parameters defining whether one or more than one can be selected by the user), and/or the like.

Additionally or alternatively, in some embodiments, the machine learning circuitry 210 includes hardware, software, firmware, and/or a combination thereof, that enables access to one or more API(s), FTP connection(s), and/or the like to securely acquire, receive, retrieve, and/or otherwise identify entity data from one or more system(s) external from the intelligent data field apparatus 102 such as, for example, the tabular data structure database 106. In some embodiments, the machine learning circuitry 210 includes a separate processor, specially configured field programmable gate array (FPGA), or a specially programmed application specific integrated circuit (ASIC).

In some embodiments, the intelligent data field apparatus 102 includes the data structure circuitry 212. The data structure circuitry 212 includes hardware, software, firmware, and/or a combination thereof, that supports various functionality associated with one or more tabular data structures stored in the tabular data structure database 106. For example, in some embodiments, the data structure circuitry 212 includes hardware, software, firmware, and/or a combination thereof, that populates an intelligent data field of a tabular data structure with the content data provided by the one or more large language models 104. In some embodiments, the data structure circuitry 212 includes a separate processor, specially configured FPGA, or a specially programmed ASIC.

In some embodiments, the intelligent data field apparatus 102 includes the user interface circuitry 214. The user interface circuitry 214 includes hardware, software, firmware, and/or a combination thereof, that supports various functionality associated with a user interface. For example, in some embodiments, the user interface circuitry 214 includes hardware, software, firmware, and/or a combination thereof, that renders one or more interactive user interface elements via a user interface (e.g., a customized dashboard) of the client system 110. In some embodiments, the user interface circuitry 214 includes hardware, software, firmware, and/or a combination thereof, that determines one or more data fields associated with context data for an intelligent data field based at least in part on selection of the one or more data fields via an interactive user interface element of a user interface. In some embodiments, the user interface circuitry 214 includes hardware, software, firmware, and/or a combination thereof, that determines a prompt based at least in part on text input (e.g., prompt text input) provided via an interactive user interface element of a user interface. In some embodiments, the user interface circuitry 214 includes hardware, software, firmware, and/or a combination thereof, that determines criteria associated with a prompt based at least in part on selection of the criteria via an interactive user interface element of a user interface. In some embodiments, the user interface circuitry 214 includes a separate processor, specially configured FPGA, or a specially programmed ASIC.

In some embodiments, the communications circuitry 208 includes hardware, software, firmware, and/or a combination thereof, that initiates one or more actions with respect to a third-party application based at least in part on content data provided by the one or more large language models 104. In some embodiments, the communications circuitry 208 includes hardware, software, firmware, and/or a combination thereof, that initiates one or more actions with respect to a user device (e.g., the client system 110) based at least in part on content data provided by the one or more large language models 104.

Additionally or alternatively, in some embodiments, two or more of the sets of circuitries 202-214 are combinable. Alternatively or additionally, in some embodiments, one or more of the sets of circuitry perform some or all of the functionality described associated with another component. For example, in some embodiments, two or more of the sets of circuitry 206-214 are combined into a single module embodied in hardware, software, firmware, and/or a combination thereof. Similarly, in some embodiments, one or more of the sets of circuitry, for example the machine learning circuitry 210, data structure circuitry 212, and/or user interface circuitry 214, is/are combined with the processor 202, such that the processor 202 performs one or more of the operations described above with respect to each of these sets of circuitry 210-214.

### Example User Interfaces for Providing Intelligent Generation of Data for a Tabular Data Structure via a Large Language Model

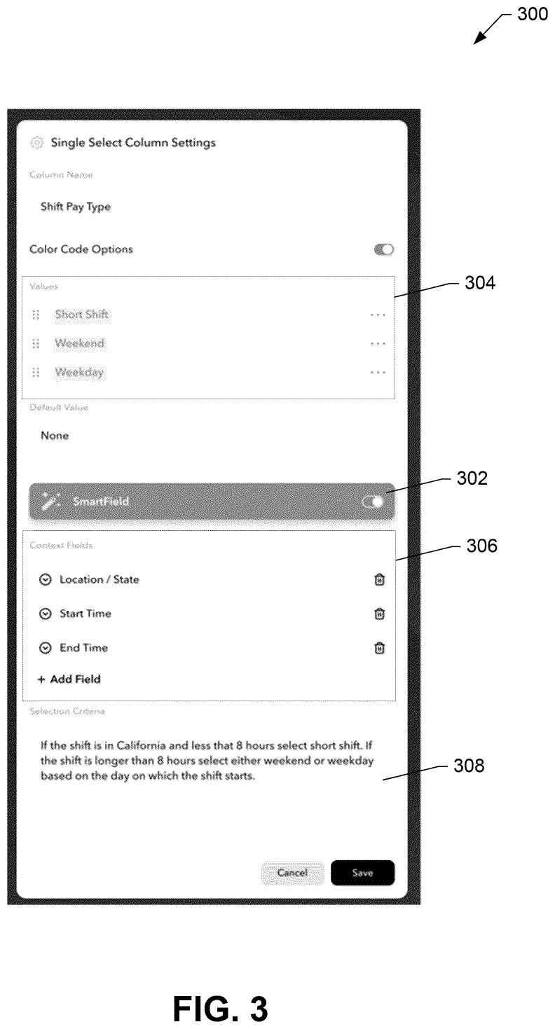

FIG. 3 illustrates an example user interface 300 as part of a process for providing intelligent generation of data for a tabular data structure in accordance with at least one example embodiment of the present disclosure. The user interface 300 is part of a graphical wizard that is displayed to a user when designating one or more cells of a tabular data structure as intelligent data cells. The user interface 300 wizard is configured to receive user input designating certain content of the tabular data structure as context; defining the output domain (e.g., by defining potential content for inclusion in the intelligent data field); and/or for providing, selecting, and/or editing one or more prompts defining what should be included in the intelligent data field. In various embodiments, one or more portions of the user interface 300 may be based on functionality between the various sub-systems of the system 100, including the intelligent data field apparatus 102, the one or more large language models 104, the tabular data structure database 106, the client system 110, and/or the network 112. For example, content and/or an arrangement of an interactive user interface element of the user interface 300 may be configured and/or rendered based on functionality between the various sub-systems of the system 100, including the intelligent data field apparatus 102, the one or more large language models 104, the tabular data structure database 106, the client system 110, and/or the network 112. In various embodiments, the user interface 300 can be rendered via a display of the client system 110. In various embodiments, the user interface 300 includes an interactive user interface element 302 that can be utilized to configure functionality of an intelligent data field of a tabular data structure stored in the tabular data structure database 106. For example, functionality of an intelligent data field can be toggled on or off via the interactive user interface element 302. In various embodiments, the one or more large language models 104 can analyze data related to one or more other data fields, account for context related to an intelligent data field, and/or automatically select or generate a data result for an intelligent data field. In various embodiments, an intelligent data field can be populated with any type of data (e.g., text, images, dates, single select, multi-select, numbers, formulas, files, etc.).

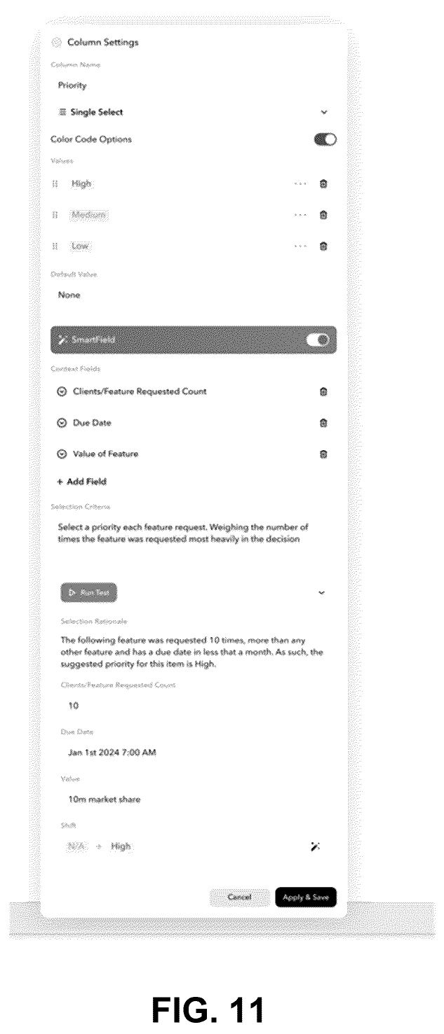

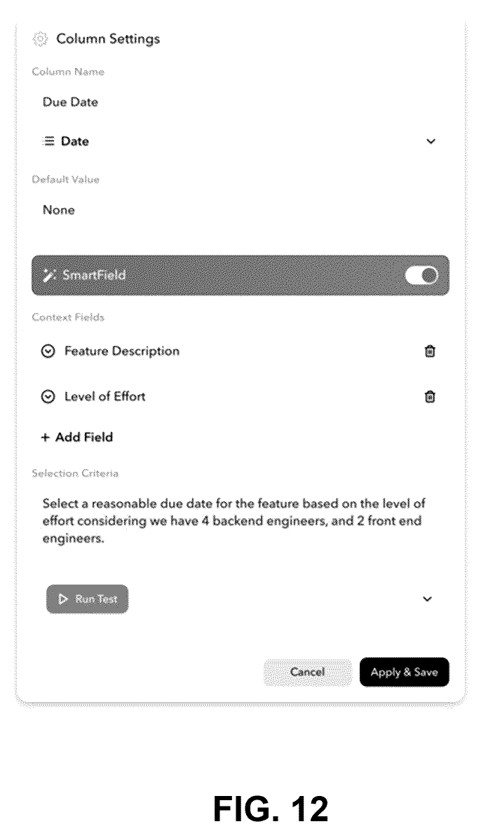

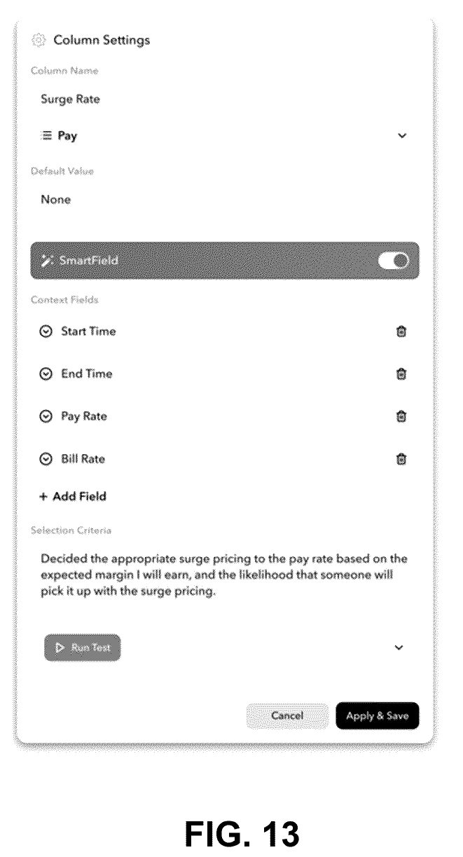

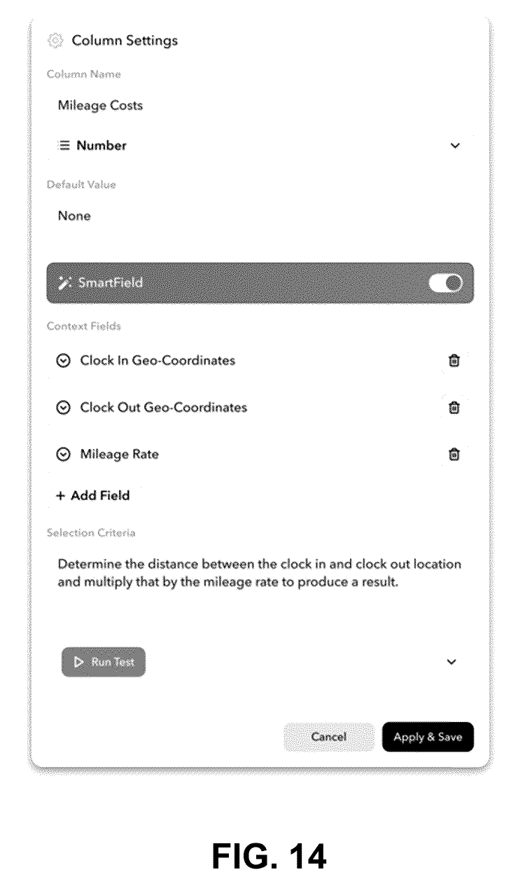

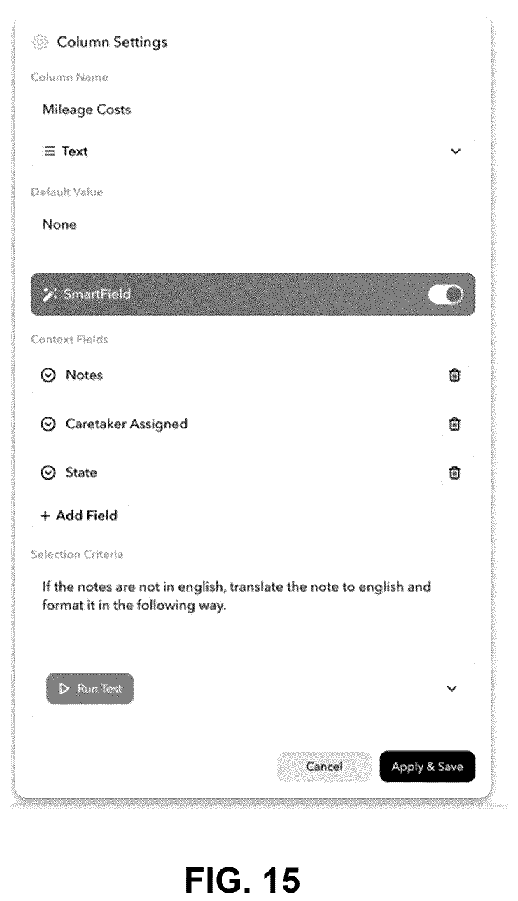

In various embodiments, the user interface additionally or alternatively includes an interactive user interface element 304 configured for selecting a type of content to create via an intelligent data field. As discussed herein, this type of content defines the output domain for the large language model to generate data for inclusion in the intelligent data field(s). For example, the interactive user interface element 304 can include a list of data field values (e.g., short shift, weekend, and weekday) that can be selected as an intelligent data field. Several examples are shown in FIGS. 11, 12, 13, 14, 15, and 16. In each of the illustrated examples, the output domains as defined by the user are contextually relevant, and based at least in part on other data within the tabular data structure corresponding to each illustrated example. In various embodiments, the interactive user interface element 304 can provide an ability of a user to configure schema associated with an intelligent data field via an edit modal.

In various embodiments, the user interface additionally or alternatively includes an interactive user interface element 306 configured for selecting context for an intelligent data field. The interactive user interface element 306 provides an ability for a user to select relevant data (e.g., relevant data fields) via the user interface 300 to utilize as input for the one or more large language models 104. For example, the interactive user interface element 306 may provide an ability for a user to select one or more data fields of a tabular data structure via the user interface 300 as context for the one or more large language models 104. In various embodiments, the relevant data can be provided with labels associated with context. For example, the selected data fields can be provided as input to the one or more large language models 104 with labels as context. In some embodiments, the selected data fields can be respectively transformed into a structured input format with a defined label that indicates a particular context. For example, a defined label can correspond to “location”, “start time” or “end time” to enable the one or more large language models 104 to understand a meaning of data included in the selected data fields. In some embodiments, the selected data fields can be respectively transformed into a key-value pair, a natural language prompt, a metadata tag, embedded metadata, or another type of input format with a defined label that indicates a particular context. In a non-limiting example, the interactive user interface element 306 can include a selection of a location/state data field, a start time data field, and an end time data field as context for an intelligent data field. As such, by utilizing the interactive user interface element 306 to select context for an intelligent data field, a user can provide context to the one or more large language models 104 via labeled input for the one or more large language models 104 without requiring the user to enter the context into a prompt. For example, the machine learning circuitry 210 can transform the selected portions of the interactive user interface element 306 into context data with the structured input format that includes a label associated with context for the selected portions. Additionally, by utilizing the interactive user interface element 306, a most relevant result may be provided via an intelligent data field. For example, the machine learning circuitry 210 can provide the context data as input to the one or more large language models 104 to enable the one or more large language models 104 to generate contextually relevant data that may be populated into the intelligent data field. In various embodiments, the context (e.g., context data) can be obtained from related data fields of one or more tabular data structures stored in the tabular data structure database 106. For example, the context can be obtained from data fields related to the use selections via the interactive user interface element 306. Additionally or alternatively, the context can be obtained from one or more other data fields (e.g., other columns) of one or more tabular data structures stored in the tabular data structure database 106. In various embodiments, the context can be additionally or alternatively obtained from data associated with an account (e.g., a user profile) of a user. In some embodiments, the context (e.g., context data) may include information that impacts data for an intelligent data field.

In various embodiments, the user interface of the displayed wizard additionally or alternatively includes an interactive user interface element 308 configured for receiving a prompt and/or selection criteria for an intelligent data field. This field of the interactive user interface element 308 is provided to receive a free-form textual entry from a user, and the large language model is configured to ingest the textual entry to determine how to implement the information/request provided by the user. For example, the interactive user interface element 308 can be utilized to describe how the one or more large language models 104 is to transpose the data. For example, a prompt that states “If the shift is in California and less than 8 hours select short shift. If the shift is longer than 8 hours select either weekend or weekday based on the day on which the shift starts” may be provided as input via the interactive user interface element 306. As such, logic and analysis provided via an intelligent data field can be simplified by utilizing the interactive user interface element 308.

In various embodiments, data associated with the interactive user interface element 306 can provide context as to which data fields impact a prompt provided via the interactive user interface element 308. In various embodiments, the interactive user interface element 302 can activate an intelligent data field to automatically select an optimal option (e.g., a correct option) from the schema values associated with the interactive user interface element 304 based on context provided via the interactive user interface element 306 and/or a prompt provided via the interactive user interface element 308.

In various embodiments, the user interface 300 can be configured to receive selection of an output domain for the output of the large language model to include in the intelligent data field. As discussed herein, the output domain defines the type of output and/or data classification for inclusion in an intelligent data field. In some embodiments, a single select option within the graphical user interface is configured to receive selection of a single type of output and/or data classification for an intelligent data field. For example, the user interface 300 can be configured to allow a user to select a single output from a specific number of allowed outputs (e.g., high priority, medium priority, and low priority, other examples, each with different output domains defined by the user based on the content within the underlying tabular data structure are shown in FIGS. 11, 12, 13, 14, 15, and 16) as a type of output for an intelligent data field. Alternatively, in some embodiments, the output domain may be defined to enable a multi-selection option, such as two or more types of output and/or data classifications for an intelligent data field that may be included in a single intelligent data field. For example, the user interface 300 can be configured to allow a user to select multiple outputs from a specific number of allowed outputs (e.g., high priority, medium priority, and low priority) as a type of output for an intelligent data field (e.g., the single output data field may include “high priority” and “low priority”). In some embodiments, selection of output from the specific number of allowed outputs can be based on user selection via the user interface 300. In some embodiments, a user can provide an indication of output and/or data classification for an intelligent data field via a prompt that indicates the output and/or data classification. In some embodiments, output and/or data classification for an intelligent data field can be explicitly defined by a user via a prompt (e.g., a manually entered prompt; an automatically generated prompt; an automatically generated prompt edited by a user; and/or the like). In some embodiments, output and/or data classification for an intelligent data field can be associated with open-ended user input provided via a prompt. In some embodiments, a prompt can define output and/or a data classification for an intelligent data field based on one or more other portions of a tabular data structure and/or predefined classifications for data fields.

In various embodiments, the user interface 300 can be utilized to configure a particular type of data field of a tabular data structure as an intelligent data field. In some examples, a type of data field may correspond to a column name. For examples, a column name may correspond to a “due date” data field, a “surge rate” data field, a “mileage cost” data field, an “assignee” data field, or another type of column name. In some examples, data provided by the one or more large language models 104 for population into the intelligent data field can correspond to a particular number value, a particular text, a particular date, a particular user identifier (e.g., a particular person), a particular currency value, or other contextually relevant data.

In various embodiments, the user interface 300 includes an interactive user interface element configured for creating an intelligent data field for a tabular data structure stored in the tabular data structure database 106. For example, the interactive user interface element can enable a user to create a name and/or a data type for the intelligent data field.

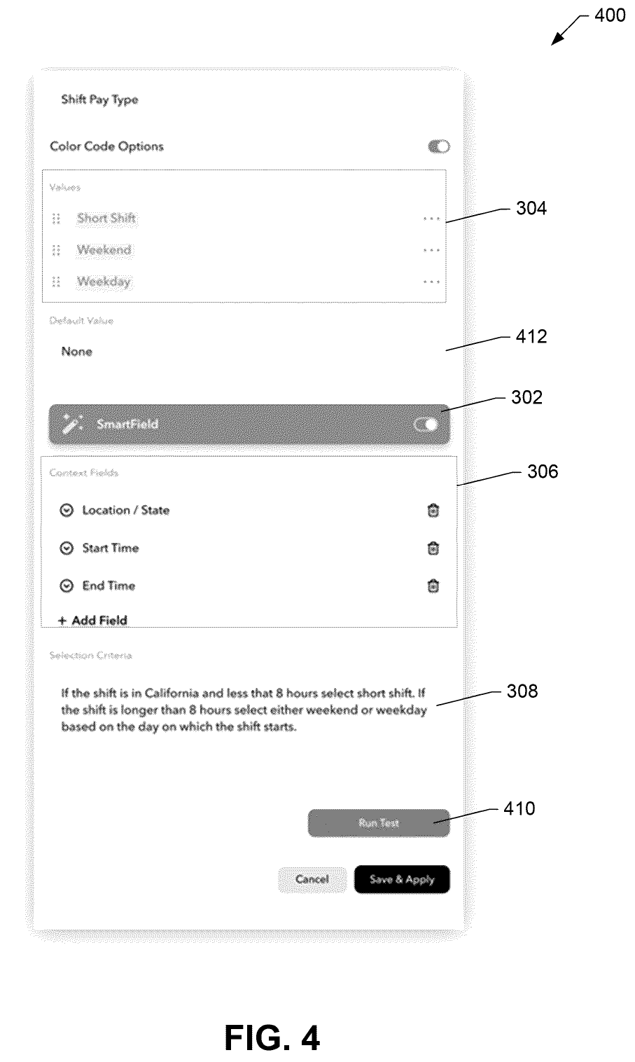

FIG. 4 illustrates an example user interface 400 as part of a process for providing intelligent generation of data for a tabular data structure in accordance with at least one example embodiment of the present disclosure. In various embodiments, one or more portions of the user interface 400 may be based on functionality between the various sub-systems of the system 100, including the intelligent data field apparatus 102, the one or more large language models 104, the tabular data structure database 106, the client system 110, and/or the network 112. For example, content and/or an arrangement of an interactive user interface element of the user interface 400 may be configured and/or rendered based on functionality between the various sub-systems of the system 100, including the intelligent data field apparatus 102, the one or more large language models 104, the tabular data structure database 106, the client system 110, and/or the network 112. In various embodiments, the user interface 400 can be rendered via a display of the client system 110. The user interface 400 can be an alternate embodiment of the user interface 300. In various embodiments, the user interface 400 includes the interactive user interface element 302, the interactive user interface element 304, the interactive user interface element 306, the interactive user interface element 308, and/or an interactive user interface element 410. The interactive user interface element 410 can be configured for initiating a test (e.g., running a test) to determine whether logic associated with an intelligent data field produces an outcome. For example, the data structure circuitry 212 can initiate the test with respect to an isolated testing space with respect to the tabular data structure database 106 based on the logic to determine whether the intelligent data field can be successfully populated with contextually relevant data using the context data fields associate with the interactive user interface element 306. In some embodiments, the user interface 400 can provide an indication of a successful test or an unsuccessful test for the intelligent data field. Additionally, in response to a successful test, the user interface 400 can provide an ability for a user to authorize execution of the one or more large language models 104 based on context data associated with the logic. The test may be additionally or alternatively utilized to pre-handle any potential errors associated with an intelligent data field in response to an unsuccessful test. For example, the data structure circuitry 212 can provide one or more recommendation for context data and/or may modify context data for the one or more large language models in response to an unsuccessful test.

In various embodiments, the user interface 400 additionally includes an interactive user interface element 412 configured for providing an ability to select default values for one or more data fields and/or an intelligent data field. As such, by utilizing selected default values rather than output of the one or more large language models 104, the interactive user interface element 412 can be utilized to minimize a number of unnecessary automations related to an intelligent data field.

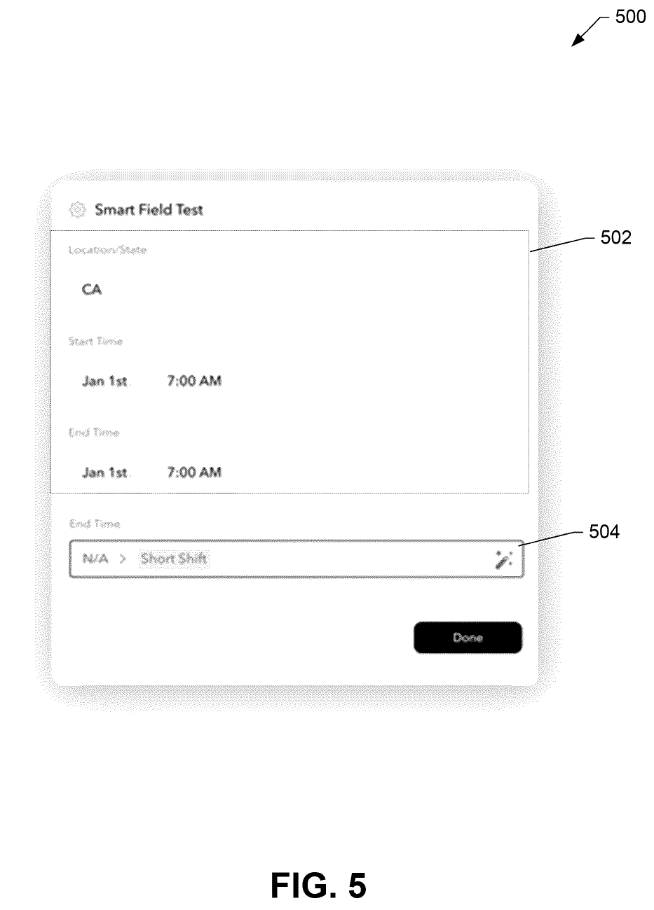

FIG. 5 illustrates an example user interface 500 as part of a process for providing intelligent generation of data for a tabular data structure in accordance with at least one example embodiment of the present disclosure. In various embodiments, one or more portions of the user interface 500 may be based on functionality between the various sub-systems of the system 100, including the intelligent data field apparatus 102, the one or more large language models 104, the tabular data structure database 106, the client system 110, and/or the network 112. For example, content and/or an arrangement of an interactive user interface element of the user interface 500 may be configured and/or rendered based on functionality between the various sub-systems of the system 100, including the intelligent data field apparatus 102, the one or more large language models 104, the tabular data structure database 106, the client system 110, and/or the network 112. In various embodiments, the user interface 500 can be rendered via a display of the client system 110. In various embodiments, the user interface 500 can be rendered in response to initiation of a test via the interactive user interface element 410. In various embodiments, the user interface 500 includes an interactive user interface element 502 configured for displaying and/or configuring one or more data fields utilized for context for an intelligent data field. In various embodiments, the user interface 500 additionally or alternatively includes an interactive user interface element 504 configured for displaying a change to a tabular data structure via an intelligent data field. For example, the interactive user interface element 504 can display data provided via an intelligent data field. In various embodiments, the interactive user interface element 504 can display data provided by the one or more one or more large language models 104.

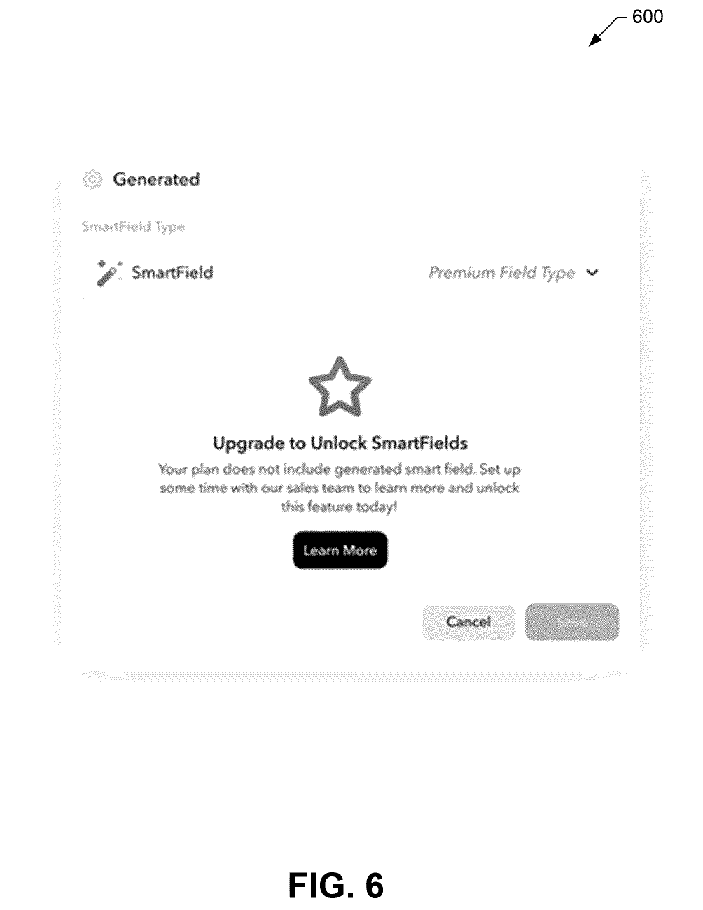

FIG. 6 illustrates an example user interface 600 as part of a process for providing intelligent generation of data for a tabular data structure in accordance with at least one example embodiment of the present disclosure. In various embodiments, one or more portions of the user interface 600 may be based on functionality between the various sub-systems of the system 100, including the intelligent data field apparatus 102, the one or more large language models 104, the tabular data structure database 106, the client system 110, and/or the network 112. For example, content and/or an arrangement of an interactive user interface element of the user interface 600 may be configured and/or rendered based on functionality between the various sub-systems of the system 100, including the intelligent data field apparatus 102, the one or more large language models 104, the tabular data structure database 106, the client system 110, and/or the network 112. In various embodiments, the user interface 600 can be rendered via a display of the client system 110. In various embodiments, the user interface 600 can be configured to selectively enable or disable functionality of an intelligent data field and/or the one or more large language models 104 for a tabular data structure stored in the tabular data structure database 106 based on one or more user interactions with respect to the user interface 600 and/or a user device (e.g., the client system 110).

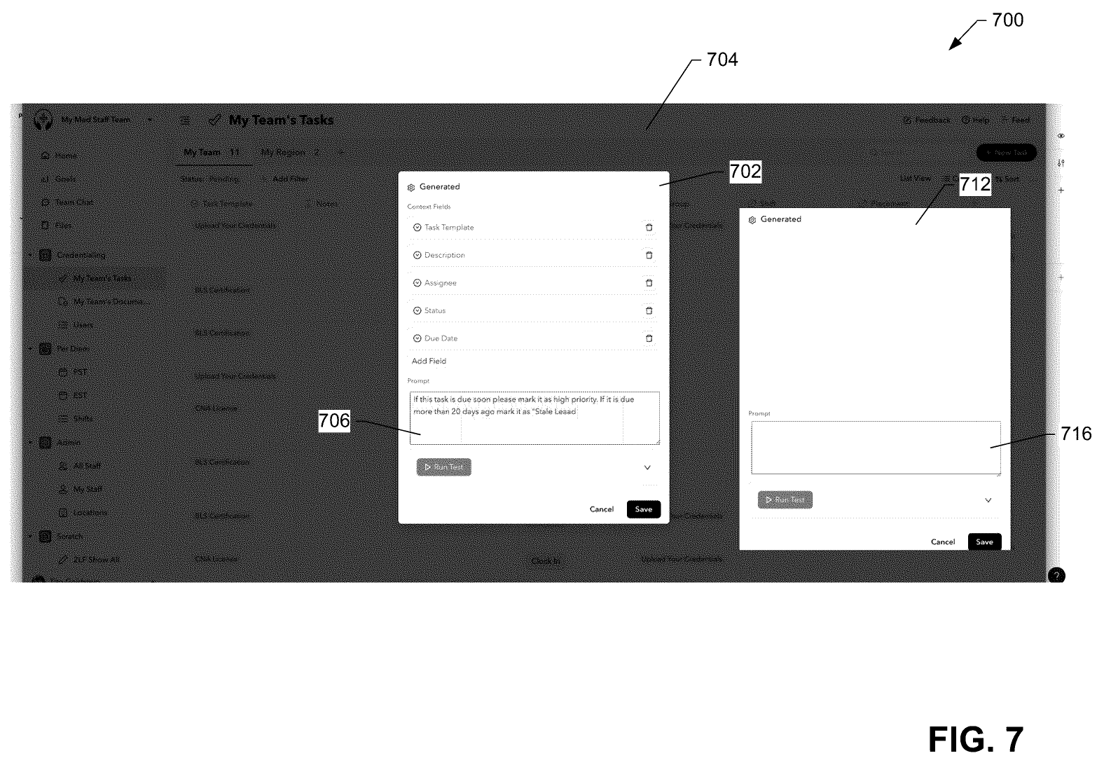

FIG. 7 illustrates an example user interface 700 as part of a process for providing intelligent generation of data for a tabular data structure in accordance with at least one example embodiment of the present disclosure. In various embodiments, one or more portions of the user interface 700 may be based on functionality between the various sub-systems of the system 100, including the intelligent data field apparatus 102, the one or more large language models 104, the tabular data structure database 106, the client system 110, and/or the network 112. For example, content and/or an arrangement of an interactive user interface element of the user interface 700 may be configured and/or rendered based on functionality between the various sub-systems of the system 100, including the intelligent data field apparatus 102, the one or more large language models 104, the tabular data structure database 106, the client system 110, and/or the network 112. In various embodiments, the user interface 700 can be rendered via a display of the client system 110. In various embodiments, the user interface 700 includes an interactive user interface element 702. In various embodiments, the interactive user interface element 702 can be rendered in response to creation of an intelligent data field via a tabular data structure user interface 704. In various embodiments, the interactive user interface element 702 is configured for determining context for data generated by the one or more large language models 104. For example, the interactive user interface element 702 can allow a user to select and/or add one or more data fields of a tabular data structure to utilize as context for data generated for the intelligent data field. In various embodiments, the interactive user interface element 702 is additionally or alternatively configured for providing a prompt input field to receive text (e.g., a text prompt) and/or selection criteria for the intelligent data field. For example, the interactive user interface element 702 can be utilized to describe how the one or more large language models 104 is to transpose the data for the intelligent data field.

In some embodiments, the interactive user interface element 702 enables entry of a prompt 706 to defines criteria for content data generated by the one or more large language models 104 to populate the intelligent data field. For example, the prompt 706 can define criteria in order to ensure the desired output from the one or more large language models 104. Prompts may be manually entered, automatically generated, and/or manually edited versions of the automatically generated prompts. In some embodiments, the large language model may be configured to automatically generate a proposed prompt based at least in part on the user's designation of an output domain and context data to be used when generating content for an intelligent data field. The prompt is a text string within a field of the illustrated wizard, and may be editable by the user (including deleting the entire prompt so the user can enter their own prompt). In some embodiments, the one or more large language models 104 may utilize a set of intelligent cascading prompts to determine criteria for the output of the one or more large language models. For example, a first prompt may be generated automatically, and a user may choose to edit the first prompt (or may choose not to edit the first prompt). Once a user determines that the first prompt is acceptable, the large language model may generate a cascaded second prompt (e.g., that uses output generated based on the first prompt as input) and/or one or more subsequent prompts such as at least a prompt 716 can be independently generated and/or utilized based on analysis and/or insights with respect to data in the tabular data structure. In some examples, an interactive user interface element 712 that is rendered subsequent to the interactive user interface element 702 can include the prompt 716 to further defines criteria for content data generated by the one or more large language models 104 to populate the intelligent data field. In some embodiments, the prompt 716 can be provided via the interactive user interface element 702 rather than a separate interactive user interface element. In some embodiments, the prompt 716 is a second prompt that rendered via the user interface 700 based on data associated with the one or more selected data fields of a tabular data structure presented via the tabular data structure user interface 704. For example, the prompt 716 can be rendered based on a determination by the data structure circuitry 212 via analysis and/or insights with respect to data in the tabular data structure that additional information would be beneficial for determining formatting criteria for output of the one or more large language models 104.

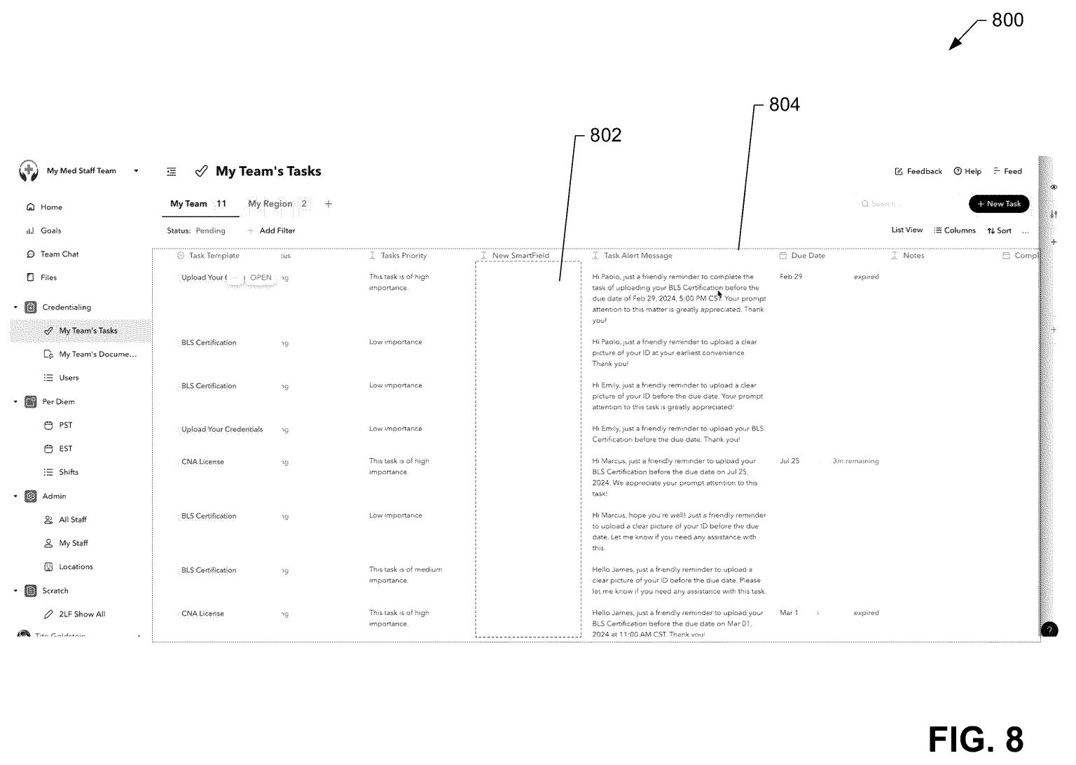

FIG. 8 illustrates an example user interface 800 as part of a process for providing intelligent generation of data for a tabular data structure in accordance with at least one example embodiment of the present disclosure. In various embodiments, one or more portions of the user interface 800 may be based on functionality between the various sub-systems of the system 100, including the intelligent data field apparatus 102, the one or more large language models 104, the tabular data structure database 106, the client system 110, and/or the network 112. For example, content and/or an arrangement of an interactive user interface element of the user interface 800 may be configured and/or rendered based on functionality between the various sub-systems of the system 100, including the intelligent data field apparatus 102, the one or more large language models 104, the tabular data structure database 106, the client system 110, and/or the network 112. In various embodiments, the user interface 800 can be rendered via a display of the client system 110. The user interface 800 can visually display a tabular data structure 804. The tabular data structure 804 can include a set of rows and a set of columns with intersecting data fields (e.g., data cells). A data field (e.g., a data cell) of the tabular data structure 804 may be populated with a data value, numbers, a formula, text, a reference to another data field, or other data. A row may represent a horizontal arrangement of data fields that extends across multiple columns. A column may represent a vertical arrangement of data fields that extends across multiple rows. In examples, the tabular data structure 804 can include a column 802 that includes a plurality of intelligent data fields prior to content data being added into the plurality of intelligent data fields by the one or more large language models 104. In some embodiments, the data structure circuitry 212 can generate the plurality of intelligent data fields simultaneously using, for example, the user interface 300, the user interface 400, or another user interface disclosed herein.

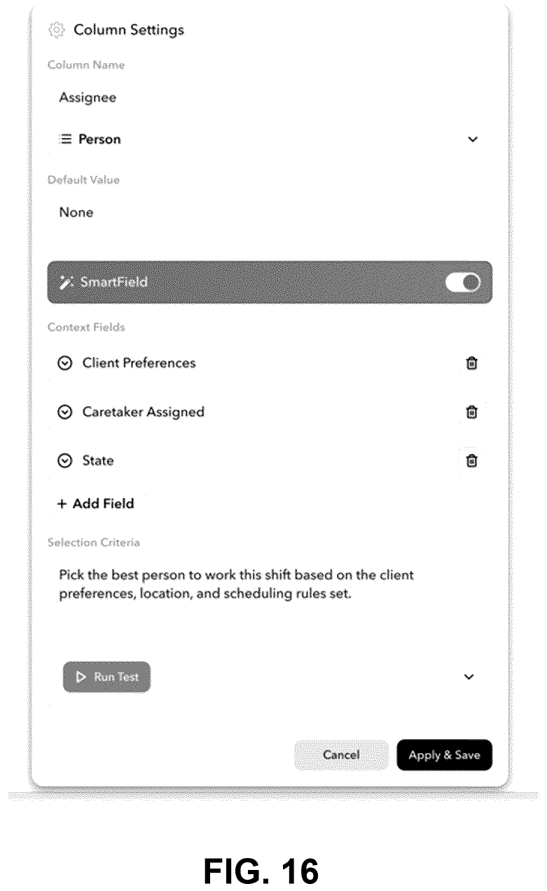

FIG. 16 illustrates an example user interface 900 as part of a process for providing intelligent generation of data for a tabular data structure in accordance with at least one example embodiment of the present disclosure. In various embodiments, one or more portions of the user interface 900 may be based on functionality between the various sub-systems of the system 100, including the intelligent data field apparatus 102, the one or more large language models 104, the tabular data structure database 106, the client system 110, and/or the network 112. For example, content and/or an arrangement of an interactive user interface element of the user interface 900 may be configured and/or rendered based on functionality between the various sub-systems of the system 100, including the intelligent data field apparatus 102, the one or more large language models 104, the tabular data structure database 106, the client system 110, and/or the network 112. In various embodiments, the user interface 900 can be rendered via a display of the client system 110. In various embodiments, the user interface 900 includes a tabular data structure 902. Additionally, in various embodiments, the user interface 900 includes an interactive user interface element 904. The interactive user interface element 904 can be configured for transforming a data field of the tabular data structure 902 into an intelligent data field. For example, the interactive user interface element 904 may include a secondary interactive user interface element 906 that initiates display of the user interface 300, the user interface 400, or another user interface disclosed herein to enable a user to configure functionality of the intelligent data field.

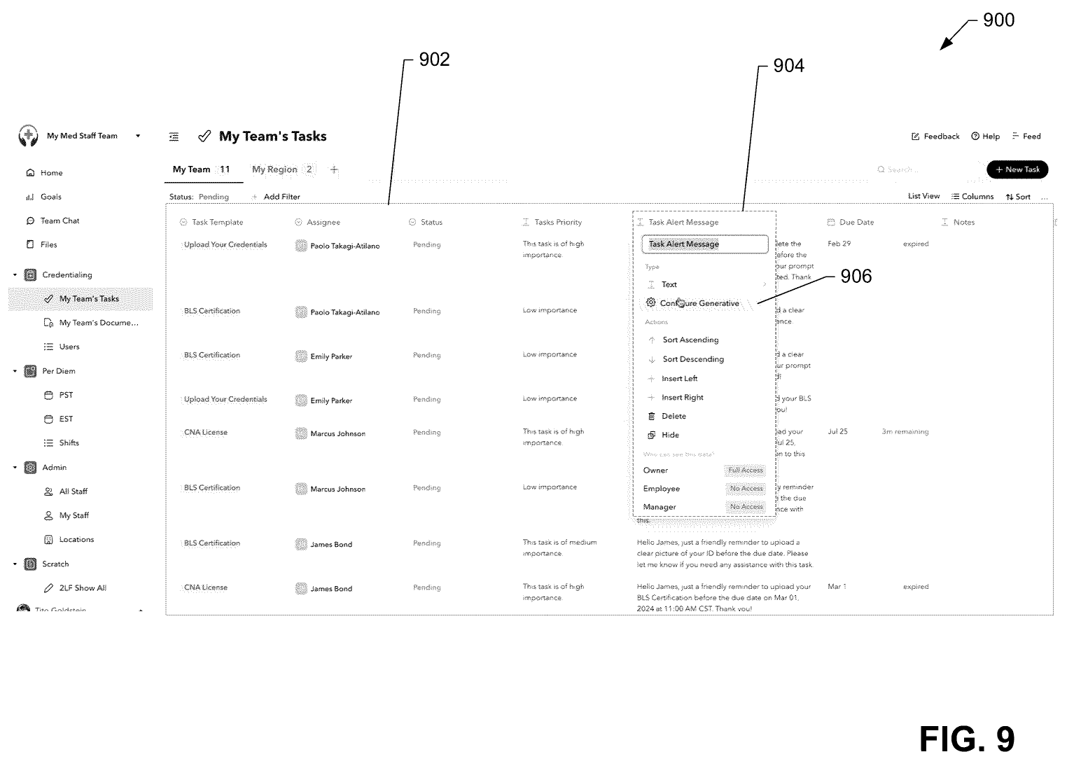

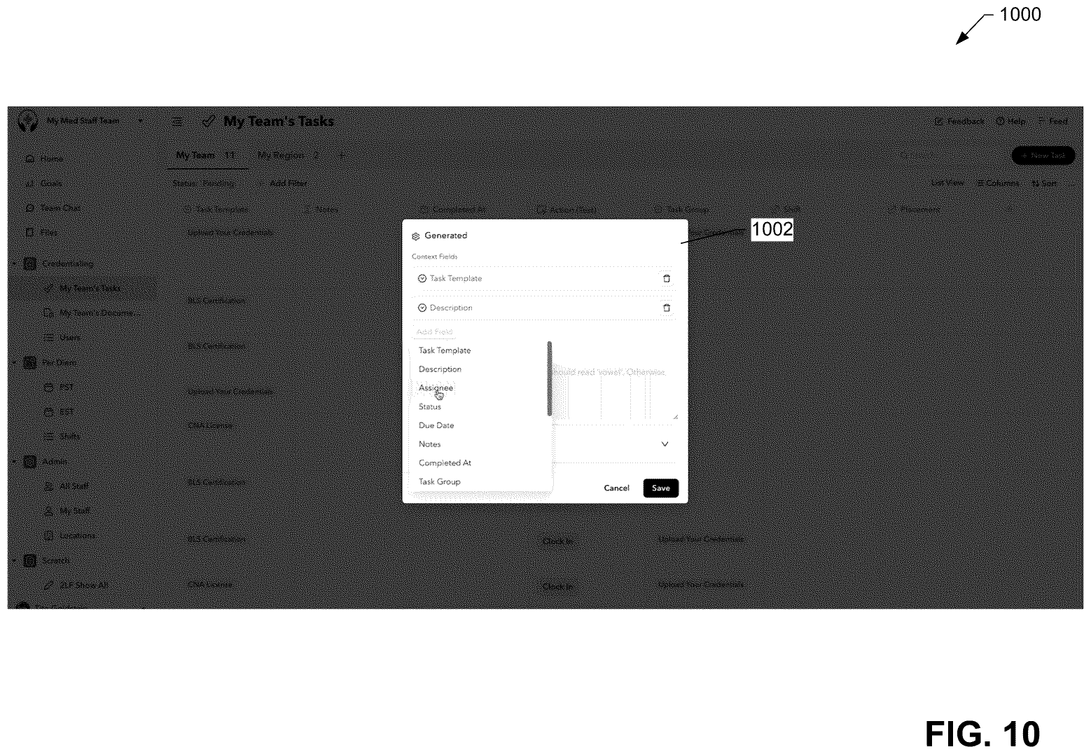

FIG. 10 illustrates an example user interface 1000 as part of a process for providing intelligent generation of data for a tabular data structure in accordance with at least one example embodiment of the present disclosure. In various embodiments, one or more portions of the user interface 1000 may be based on functionality between the various sub-systems of the system 100, including the intelligent data field apparatus 102, the one or more large language models 104, the tabular data structure database 106, the client system 110, and/or the network 112. For example, content and/or an arrangement of an interactive user interface element of the user interface 1000 may be configured and/or rendered based on functionality between the various sub-systems of the system 100, including the intelligent data field apparatus 102, the one or more large language models 104, the tabular data structure database 106, the client system 110, and/or the network 112. In various embodiments, the user interface 1000 can be rendered via a display of the client system 110. For example, the user interface 1000 can be rendered in response to a user interaction with respect to the secondary interactive user interface element 906 illustrated in FIG. 9 to enable a user to configure functionality of the intelligent data field. In various embodiments, the user interface 1000 includes an interactive user interface element 1002 configured for selecting one or more data fields of a tabular data structure for context via a dropdown list widget that includes a list of candidate data fields. For example, interactive user interface element 1002 can allow a user to select one or more data fields of a tabular data structure for utilization as context for an intelligent data field. In various embodiments, the interactive user interface element 1002 can include a multi-selection option that allows selection of two or more data fields for an intelligent data field.

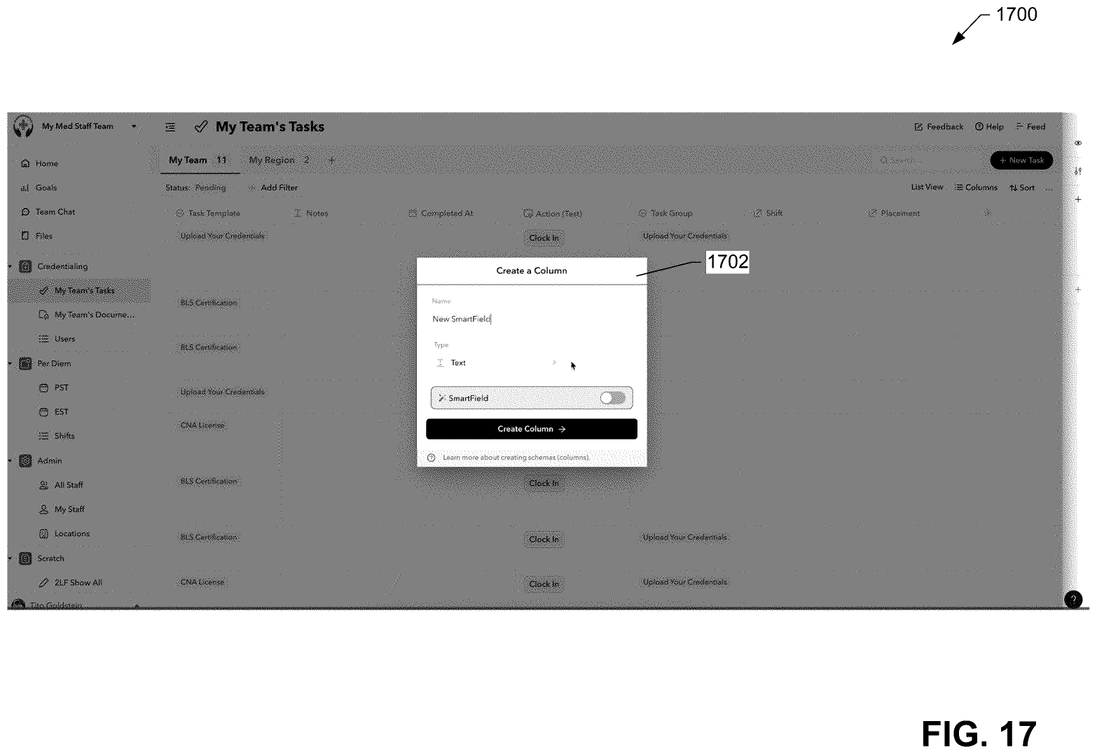

FIG. 17 illustrates an example user interface 1700 as part of a process for providing intelligent generation of data for a tabular data structure in accordance with at least one example embodiment of the present disclosure. In various embodiments, one or more portions of the user interface 1700 may be based on functionality between the various sub-systems of the system 100, including the intelligent data field apparatus 102, the one or more large language models 104, the tabular data structure database 106, the client system 110, and/or the network 112. For example, content and/or an arrangement of an interactive user interface element of the user interface 1700 may be configured and/or rendered based on functionality between the various sub-systems of the system 100, including the intelligent data field apparatus 102, the one or more large language models 104, the tabular data structure database 106, the client system 110, and/or the network 112. In various embodiments, the user interface 1700 can be rendered via a display of the client system 110. In various embodiments, the user interface 1700 includes an interactive user interface element 1702 configured for creating an intelligent data field for a tabular data structure stored in the tabular data structure database 106. For example, interactive user interface element 1702 can allow a user to create a name and/or a data type for the intelligent data field.

### Example Method for Providing Intelligent Generation of Data for a Tabular Data Structure via a Large Language Model

Having described example systems in accordance with the present disclosure, example processes of the present disclosure will now be discussed. It will be appreciated that each of the flowcharts depicts an example computer-implemented process that is performable by one or more apparatuses, systems, circuits, devices, and/or computer program products described herein, for example utilizing one or more of the specially configured components thereof.

Although the example processes depict a particular sequence of operations, the sequence may be altered without departing from the scope of the present disclosure. For example, some of the operations depicted may be performed in parallel or in a different sequence that does not materially affect the function of the processes.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

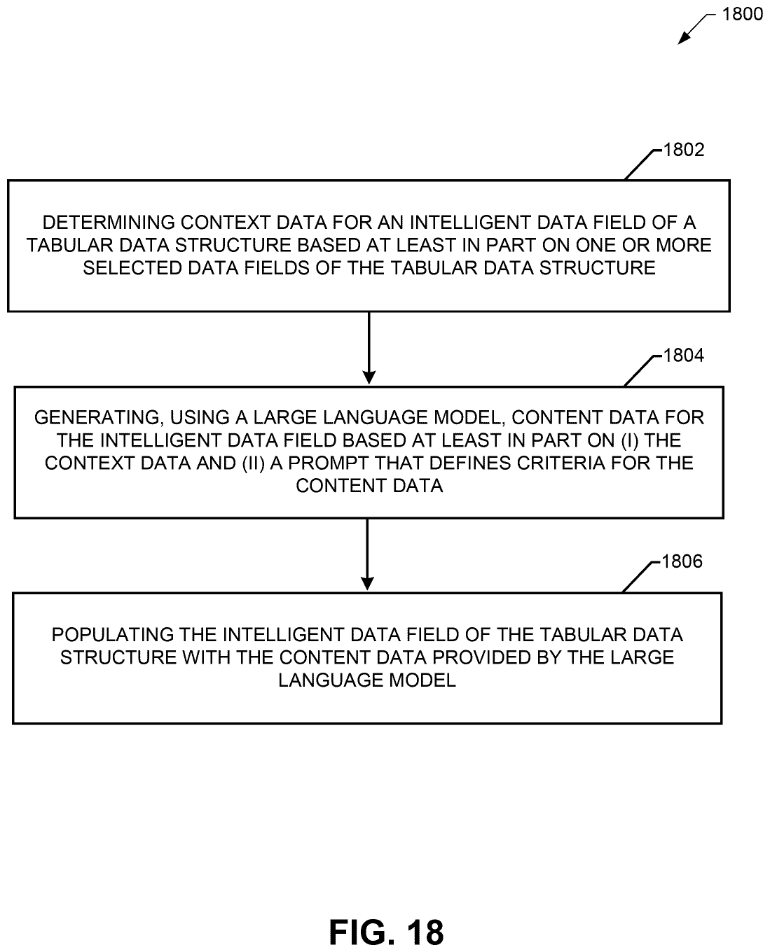

FIG. 18 illustrates a process 1800 depicting example operations for providing intelligent generation of data for a tabular data structure via a large language model in accordance with one or more embodiments of the present disclosure. The process may embody an example computer-implemented method. In some embodiments, the process 1800 is embodied by computer program code stored on a non-transitory computer-readable storage medium of a computer program product configured for execution to perform the process as depicted and described. Alternatively or additionally, in some embodiments, the process is performed by one or more specially configured computing devices, such as the intelligent data field apparatus 102 alone or in communication with one or more other component(s), device(s), system(s), and/or the like. In this regard, in some embodiments, the intelligent data field apparatus 102 is specially configured by computer-coded instructions (e.g., computer program instructions) stored thereon, for example in memory and/or another component depicted and/or described herein and/or otherwise accessible to the intelligent data field apparatus 102, for performing the operations as depicted and described. In some embodiments, the intelligent data field apparatus 102 is in communication with one or more external apparatus(es), system(s), device(s), and/or the like, to perform one or more of the operations as depicted and described. For purposes of simplifying the description, the process 1800 is described as performed by and from the perspective of the intelligent data field apparatus 102.

In some embodiments, the process 1800 includes determining (e.g., by the processor 202 and/or the machine learning circuitry 210) context data for an intelligent data field of a tabular data structure based at least in part on one or more other data fields of the tabular data structure, as shown at block 1802. For instance, in some embodiments, the processor 202 and/or the machine learning circuitry 210 determines context data for an intelligent data field of a tabular data structure based at least in part on one or more selected data fields of the tabular data structure. In some embodiments, the one or more other data fields (e.g., the one or more selected data fields) are determined based at least in part on selection of the one or more other data fields (e.g., the one or more selected data fields) via an interactive user interface element of a user interface. In some embodiments, the processor 202 and/or the machine learning circuitry 210 determines the context data based at least in part on data included within the one or more other data fields (e.g., the one or more selected data fields).

In some embodiments, the context data is provided in the form of contextual data that may limit or guide the type of data that is entered into the intelligent data field (e.g., numbers, date, name, description, etc.). For example, the context data may refer to information or data provided as input to a large language model to provide relevance and/or meaning with respect to the intelligent data field. In some embodiments, the context data may include information or data in certain types of data fields in the tabular data structure, structure or formatting of data fields in the tabular data structure, relationships between data fields in the tabular data structure, content of data fields in the tabular data structure, and/or other contextual insights related to data fields in the tabular data structure. In some embodiments, the context data used for limiting or guiding the output of the large language model may be manually selected. For example, the system may be configured to receive user input selecting one or more other data fields via a graphical user interface to determine the context data for the intelligent data field.

In some embodiments, the process 1800 includes generating (e.g., by the processor 202 and/or the machine learning circuitry 210), using a large language model, content data for the intelligent data field based at least in part on (i) the context data and (ii) a prompt that defines criteria for the content data, as shown at block 1804. For instance, in some embodiments, the processor 202 and/or the machine learning circuitry 210 inputs (i) the context data and (ii) a prompt that defines output data formatting criteria into a large language model to generate contextually-relevant content data for the intelligent data field. The output data formatting criteria can include criteria regarding format, structure, and/or content preferences for output (e.g., the contextually-relevant content data) of the large language model. In some embodiments, the processor 202 and/or the machine learning circuitry 210 determines the prompt based at least in part on text input provided via an interactive user interface element of a user interface. In some embodiments, the processor 202 and/or the machine learning circuitry 210 generates the prompt based at least in part on data associated with the one or more other data fields (e.g., the one or more selected data fields) of the tabular data structure. In some embodiments, the prompt is a second prompt that is generated subsequent to a first prompt. In some embodiments, the processor 202 and/or the machine learning circuitry 210 generates the second prompt based at least in part on data associated with the one or more other data fields (e.g., the one or more selected data fields) of the tabular data structure.

In some embodiments, the process 1800 includes populating (e.g., by the processor 202 and/or the data structure circuitry 212) the intelligent data field of the tabular data structure with the content data provided by the large language model, as shown at block 1806. For instance, in some embodiments, the processor 202 and/or the machine learning circuitry 210 populates the intelligent data field of the tabular data structure with the contextually-relevant content data generated by the large language model. In some embodiments, the processor 202 and/or the input/output circuitry 206 initiates one or more actions with respect to a third-party application based at least in part on the content data (e.g., the contextually-relevant content data) provided by the large language model. In some embodiments, the processor 202 and/or the input/output circuitry 206 initiates one or more actions with respect to a user device based at least in part on the content data (e.g., the contextually-relevant content data) provided by the large language model. The one or more actions may include an action within the tabular data structure, an action with respect to the tabular data structure database 106 that stores the tabular data structure, an action using a third-party application, an action with respect to the network 112, an action using an API, an action with respect to the client system 110 (e.g., a user device), an action with respect to a user interface, and/or another type of action.

In some embodiments, an action may cause a real-world change, for example, by controlling a hardware component of the client system 110 (e.g., a user device) or a server device of the network 112, providing alerts, interactive actions, and/or the like. For instance, an action may comprise the initiation of automated instructions across and between devices, automated notifications, automated data processing actions, and/or the like. In some embodiments, an action may cause transmission of an API call (e.g., via the network 112) to a third-party application to cause the third-party application to execute one or more computer-executable instructions associated with one or more computing tasks capable of being performed by the third-party application. In some embodiments, an action may cause transmission of a control signal (e.g., via the network 112) to the client system 110 (e.g., a user device) to cause the client system 110 to execute one or more computer-executable instructions associated with one or more computing tasks capable of being performed by the client system 110.

In some embodiments where an action is within the tabular data structure and/or an action is with respect to the tabular data structure database 106 that stores the tabular data structure, the processor 202 and/or the data structure circuitry 212 additionally populates content data into one or more data fields of the tabular data structure based on the contextually-relevant content data populated into the intelligent data field, where the one or more data fields are not configured as intelligent data fields. In some embodiments where the intelligent data field is populated with a specific value [X], the processor 202 and/or the data structure circuitry 212 may automatically generate a new column for the tabular data structure and/or a different tabular data structure. In some embodiments, the new column may include a corresponding value [Y]. In some embodiments, the processor 202 and/or the data structure circuitry 212 may monitor the intelligent data field for trigger values, execute the large language model to determine the [Y] value, and/or dynamically modify one or more other portions of the tabular data structure based on the contextually-relevant content data populated into the intelligent data field. In some embodiments, the processor 202 and/or the data structure circuitry 212 may utilize a set of rules for data fields to enable population of the content data into the one or more data fields that are not configured as intelligent data fields.

In some embodiments, the processor 202 and/or the input/output circuitry 206 initiates the one or more actions based on an interaction event with respect to the tabular data structure and/or another tabular data structure. For example, the processor 202 and/or the input/output circuitry 206 may initiate a notification that is presented via the client system 110 (e.g., a user device) when a user accesses the tabular data structure. In another example, the processor 202 and/or the input/output circuitry 206 may initiate a notification that is presented via the client system 110 (e.g., a user device) when a user accesses a different tabular data structure stored in the tabular data structure database 106. In another example, the processor 202 and/or the input/output circuitry 206 may initiate a notification for presentation via the client system 110 (e.g., a user device) whether or not a user is actively interacting with the tabular data structure. The notification may include a graphical notification and/or an audio notification. In some embodiments, the notification is transmitted via the network 112, causing the client system 110 (e.g., a user device) to execute instructions to display the notification via a user interface and/or present audio associated with the notification via a speaker. In some embodiments, the processor 202 and/or the input/output circuitry 206 initiates the one or more actions based on specific values included in the intelligent data field, changes in data for the tabular data structure, and/or other predefined conditions associated with the tabular data structure. In some embodiments, the processor 202 and/or the input/output circuitry 206 may utilize API calls to third-party applications to facilitate the delivery of the notification via the network 112.

In some embodiments, the processor 202 and/or the input/output circuitry 206 initiates a third-party workflow based on an interaction event with respect to the tabular data structure. In some embodiments, initiation of the third-party workflow includes transmitting a signal via the network 112 to start third-party application on the client system 110 (e.g., a user device) or a remote server accessible via the network 112. In some embodiments, the processor 202 and/or the input/output circuitry 206 may provide data extracted from the tabular data structure to the third-party application to execute a defined task via the third-party application. In some embodiments, the defined task includes, but is not limited to, sending an email, sending a direct message, populating an expense report, executing another predefined action, or another type of defined tasks associated with the third-party application. In some embodiments, the processor 202 and/or the input/output circuitry 206 causes the third-party application to execute the defined task immediately or substantially immediately (e.g., in real time) upon receiving the data via the network 112. In some embodiments, the processor 202 and/or the input/output circuitry 206 may instruct the third-party application to execute the defined task at a specified future time and/or based on computing resource availability for the client system 110 (e.g., a user device) or a remote server accessible via the network 112. In some embodiments, the initiation of the third-party workflows may be triggered based on specific values included in the intelligent data field, changes in data for the tabular data structure, and/or other predefined conditions associated with the tabular data structure. In some embodiments, the processor 202 and/or the input/output circuitry 206 may utilize an API call to communicate with and/or control the third-party applications, thereby causing the third-party application to execute one or more computer-executable instructions associated with the defined task. In some embodiments, the processor 202 and/or the input/output circuitry 206 may transmit a control signal to the client system 110 (e.g., a user device), thereby causing the client system 110 (e.g., a user device) to execute the third-party application to perform the defined task.

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, e.g., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. An apparatus comprising one or more processors and one or more storage devices storing instructions that are operable, when executed by the one or more processors, to cause the one or more processors to:
determine context data for an intelligent data field of a tabular data structure based at least in part on one or more selected data fields of the tabular data structure;
input (i) the context data and (ii) a prompt that defines output data formatting criteria into a large language model to generate contextually-relevant content data for the intelligent data field; and
populate the intelligent data field of the tabular data structure with the contextually-relevant content data generated by the large language model.

2. The apparatus of claim 1, wherein the one or more storage devices store instructions that are operable, when executed by the one or more processors, to further cause the one or more processors to:
determine the one or more selected data fields based at least in part on selection of the one or more selected data fields via an interactive user interface element of a user interface.

3. The apparatus of claim 1, wherein the one or more storage devices store instructions that are operable, when executed by the one or more processors, to further cause the one or more processors to:
determine the prompt based at least in part on text input provided via an interactive user interface element of a user interface.

4. The apparatus of claim 1, wherein the one or more storage devices store instructions that are operable, when executed by the one or more processors, to further cause the one or more processors to:
determine the context data based at least in part on data included within the one or more selected data fields.

5. The apparatus of claim 1, wherein the one or more storage devices store instructions that are operable, when executed by the one or more processors, to further cause the one or more processors to:
initiate one or more actions in a third-party application based at least in part on the contextually-relevant content data provided by the large language model.

6. The apparatus of claim 1, wherein the one or more storage devices store instructions that are operable, when executed by the one or more processors, to further cause the one or more processors to:
initiate one or more actions with respect to a user device based at least in part on the contextually-relevant content data provided by the large language model.

7. The apparatus of claim 1, wherein the prompt is a second prompt that is generated subsequent to a first prompt.

8. The apparatus of claim 7, wherein the one or more storage devices store instructions that are operable, when executed by the one or more processors, to further cause the one or more processors to:
generate the second prompt based at least in part on data associated with the one or more selected data fields of the tabular data structure.

9. A computer-implemented method, comprising:
determining context data for an intelligent data field of a tabular data structure based at least in part on one or more selected data fields of the tabular data structure;
inputting (i) the context data and (ii) a prompt that defines output data formatting criteria into a large language model to generate contextually-relevant content data for the intelligent data field; and
populating the intelligent data field of the tabular data structure with the contextually-relevant content data generated by the large language model.

10. The method of claim 9, further comprising:
determining the one or more selected data fields based at least in part on selection of the one or more selected data fields via an interactive user interface element of a user interface.

11. The method of claim 9, further comprising:
determining the prompt based at least in part on text input provided via an interactive user interface element of a user interface.

12. The method of claim 9, further comprising:
determining the context based at least in part on data included within the one or more selected data fields.

13. The method of claim 9, further comprising:
initiating one or more actions in a third-party application based at least in part on the contextually-relevant content data provided by the large language model.

14. The method of claim 9, further comprising:
initiating one or more actions with respect to a user device based at least in part on the contextually-relevant content data provided by the large language model.

15. The method of claim 9, further comprising:
generating the prompt based at least in part on data associated with the one or more selected data fields of the tabular data structure.

16. One or more non-transitory computer-readable storage media storing instructions that, when executed by one or more processors, cause the one or more processors to:
determine context data for an intelligent data field of a tabular data structure based at least in part on one or more selected data fields of the tabular data structure;
input (i) the context data and (ii) a prompt that defines output data formatting criteria into a large language model to generate contextually-relevant content data for the intelligent data field; and
populate the intelligent data field of the tabular data structure with the contextually-relevant content data generated by the large language model.

17. The one or more non-transitory computer-readable storage media of claim 16, wherein the instructions, when executed by the one or more processors, further cause the one or more processors to:
determine the one or more selected data fields based at least in part on selection of the one or more selected data fields via an interactive user interface element of a user interface.

18. The one or more non-transitory computer-readable storage media of claim 16, wherein the instructions, when executed by the one or more processors, further cause the one or more processors to:
determine the prompt based at least in part on text input provided via an interactive user interface element of a user interface.

19. The one or more non-transitory computer-readable storage media of claim 16, wherein the instructions, when executed by the one or more processors, further cause the one or more processors to:
determine the context data based at least in part on data included within the one or more selected data fields.

20. The one or more non-transitory computer-readable storage media of claim 16, wherein the instructions, when executed by the one or more processors, further cause the one or more processors to:
generate the prompt based at least in part on data associated with the one or more selected data fields of the tabular data structure.
